(19) United States
(12) Patent Application Publication
(10) Pub. No.: US 2024/0339695 A1
(43) Pub. Date: Oct. 10, 2024

(54) COOLING SYSTEM FOR A VEHICLE HAVING A HIGH-VOLTAGE BATTERY

(71) Applicant: Dr. Ing. h.c. F. Porsche Aktiengesellschaft, Stuttgart (DE)

(72) Inventors: Michael ENGLMEIER, Lenting (DE); Fabian ZEYHER, Stuttgart (DE); Andre ENDERS, Leonberg (DE)

(21) Appl. No.: 18/617,831

(22) Filed: Mar. 27, 2024

(30) Foreign Application Priority Data
Apr. 4, 2023 (DE) 10 2023 108 641.3

(51) Int. Cl. H01M 10/6568; B60L 50/60; H01M 10/613; H01M 10/625; H01M 10/6551; H01M 10/6556

(52) U.S. Cl. CPC H01M 10/6568; B60L 50/60; H01M 10/613; H01M 10/625; H01M 10/6551; H01M 10/6556; H01M 2220/20

(57) ABSTRACT

A cooling system for a vehicle having a high-voltage battery, including an oil cooling circuit for cooling the high-voltage battery with a first line system for distributing an oil as a coolant, a water-based cooling circuit for cooling further components of the vehicle with a second line system for distributing a water-based coolant, and a heat exchanger. The heat exchanger is arranged between the oil cooling circuit and the water-based cooling circuit for dissipating heat from the oil cooling circuit through the water-based cooling circuit.

### CROSS REFERENCE TO RELATED APPLICATIONS

This application claims benefit to German Patent Application No. DE 10 2023 108 641.3, filed on Apr. 4, 2023, which is hereby incorporated by reference herein.

### FIELD

The present invention relates to a cooling system for a vehicle having a high-voltage battery, as well as to a vehicle having such a cooling system.

### BACKGROUND

High-performance vehicles with all-electric drives require very high cooling requirements. Therefore, a complete direct oil cooling is generally used in such vehicles due to the high cooling effectiveness, in which all components, in particular the high-voltage battery or batteries, are directly circulated with a non-conductive oil, whereby high specific heat dissipation and high cooling capacities can be achieved.

Disadvantageously, such an oil cooling system requires large line cross-sections, which is particularly disadvantageous for space and weight reasons. In addition, such an oil cooling system incurs increased costs due to the necessary oil sealing, the large system expansion and the higher mass flows.

### SUMMARY

In an embodiment, the present disclosure provides a cooling system for a vehicle having a high-voltage battery, comprising an oil cooling circuit for cooling the high-voltage battery with a first line system for distributing an oil as a coolant, a water-based cooling circuit for cooling further components of the vehicle with a second line system for distributing a water-based coolant, and a heat exchanger. The heat exchanger is arranged between the oil cooling circuit and the water-based cooling circuit for dissipating heat from the oil cooling circuit through the water-based cooling circuit.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 illustrates the construction of a cooling system according to an embodiment of the invention for a vehicle having a high-voltage battery;

FIG. 2 illustrates a part of a heat exchanger according to an embodiment of the invention in a spatial view;

FIG. 3 illustrates a part of a heat exchanger according to an embodiment of the invention in a sectional view;

FIG. 4 illustrates a hollow cylinder of a heat exchanger according to an embodiment of the invention in a spatial view (left) and a housing of a heat exchanger according to an embodiment of the invention (right); and

FIG. 5 illustrates a retaining structure of a heat exchanger according to an embodiment of the invention for fixing a plurality of microchannels.

### DETAILED DESCRIPTION

In an embodiment, the present invention provides a cooling system and a vehicle having a cooling system to at least partially remedy the disadvantages described above. In particular, embodiments of the present invention provide an effective cooling system for a vehicle having a high-voltage battery that is simple and inexpensive to manufacture and is also designed to save space and weight.

Technical features and details that are disclosed in connection with the cooling system according to embodiments of the invention naturally also apply in connection with the vehicle according to embodiments of the invention, and vice versa, so that reference is or can always be mutually made with respect to the disclosure regarding the individual aspects of embodiments of the invention.

According to an embodiment of the invention, a cooling system for a vehicle having a high-voltage battery is provided. The cooling system according to an embodiment of the present invention comprises an oil cooling circuit for cooling the high-voltage battery having a first line system for distributing an oil as a coolant and a water-based cooling circuit for cooling further components of the vehicle having a second line system for distributing a water-based coolant, wherein a heat exchanger is arranged between the oil cooling circuit and the water-based cooling circuit for dissipating heat from the oil cooling circuit through the water-based cooling circuit.

According to an embodiment of the invention, the cooling system in question is thus designed, in particular by the arrangement according to an embodiment of the invention of an oil cooling circuit, a water-based cooling circuit, and a heat exchanger arranged between the oil cooling circuit and the water-based cooling circuit, to enable effective heat dissipation and at the same time to save space and weight. Furthermore, the cooling system in question can be manufactured simply and cost-effectively.

This arrangement also makes it possible to operate high-performance vehicles with all-electric drives effectively and sustainably.

A high-voltage battery can be understood in particular to mean an electrical energy storage device that provides AC voltages of over 30 V to 1 kV or DC voltages of over 60 V to 1.5 kV. Preferably, the cooling system can be configured in the form of an island cooling system, in particular an island oil cooling system. The water-based coolant can advantageously be configured as a water-glycol mixture. The further components can be configured in the form of valves and/or coolers and/or connections, for example, or the like. The cooling system in question can be used not only for all-electric vehicles, but also for hybrid vehicles.

In the context of a particularly effective removal of heat from the oil cooling circuit, it can advantageously be provided that the heat exchanger is configured in the form of a capillary heat exchanger, wherein the heat exchanger preferably comprises a hollow cylinder for passing the oil through and a plurality of microchannels for passing the water-based coolant through, wherein the microchannels are in particular woven. The hollow cylinder (the base surface) can preferably be circular. The microchannels can also be glued together, for example.

In the context of a particularly effective removal of heat from the oil cooling circuit, it can further be provided that the microchannels are arranged directly around the hollow cylinder, preferably symmetrically around the hollow cylinder, wherein the microchannels are connected to each other in particular via warp wires. The microchannels are preferably arranged substantially parallel to the cylinder or the main axis of orientation of the cylinder. A substantially parallel arrangement can also be understood to mean marginal deviations from a perfectly parallel arrangement of up to 5°.

In the context of a particularly effective introduction and removal of a water-based coolant, it can further be advantageous for the heat exchanger to comprise a housing having an inlet connection for introducing a water-based coolant and an outlet connection for removing the water-based coolant, wherein the inlet connection and the outlet connection are preferably arranged on opposite front sides of the housing. The heat exchanger can thus be configured such that a water-based coolant can be introduced through a front face of the housing or the hollow cylinder, can be guided axially through the microchannels to the opposite end face of the housing or the hollow cylinder and can be removed from the housing there.

In the context of a particularly effective introduction and removal of a coolant, it can further be advantageous for the heat exchanger to comprise a housing having an inlet connection for introducing a water-based coolant and an outlet connection for removing the water-based coolant, wherein the inlet connection and the outlet connection are preferably arranged on the same side face of the housing.

To maximize heat exchange between an oil as a coolant and a water-based coolant, it can further advantageously be provided that the hollow cylinder for passing the oil through has a plurality of deflections for changing a flow direction, wherein the hollow cylinder preferably has at least three deflections, in particular at least four deflections for changing a flow direction. The heat exchanger can thus be configured such that an oil-based coolant can be introduced into the housing or on the inside of the hollow cylinder and flows through the hollow cylinder along the deflections with increased contact to the microchannels, such that a maximum heat exchange between the oil and the water-based coolant can be achieved via a type of counterflow process and a high level of efficiency can be achieved.

Advantageously, in the context of maximizing contact between the oil cooling circuit and the water-based cooling circuit, it can be provided that the plurality of deflections are arranged at an angle to the microchannels, preferably substantially perpendicular to the microchannels.

Furthermore, it can be advantageous if the microchannels are made of a plastic or a metal material. With regard to a weight-optimized design, a design in which the microchannels are made of a plastic would be preferable. In the context of a cooling performance-optimized design, a design in which the microchannels are made of a metal material would preferably be advantageous. The following can be used as a plastic: polyether ketone, polyether ketone, or a polyimide. Copper, aluminum, titanium or steel can further be used as the metal material.

To ensure an effective cooling performance of the water-based cooling circuit, it can advantageously be provided that the microchannels have an external diameter of between 0.2 mm and 4.0 mm, preferably between 0.5 mm and 2.0 mm.

An embodiment of the invention provides a vehicle having a high-voltage battery comprising a cooling system as described above. Thus, the vehicle according to an embodiment of the invention offers the same advantages as have been described in detail above with respect to the cooling system according to embodiments the invention.

In the context of effective cooling of a high-voltage battery of a vehicle, it can also be advantageous if the high-voltage battery is arranged within the oil cooling circuit, wherein the high-voltage battery is preferably actively cooled exclusively via the oil cooling circuit.

Further advantages, features, and details of embodiments of the invention arise from the following description, in which embodiment examples of the invention are described in detail with reference to the drawings. The features mentioned in the claims and in the description can be essential for embodiments of the invention individually or in any combination.

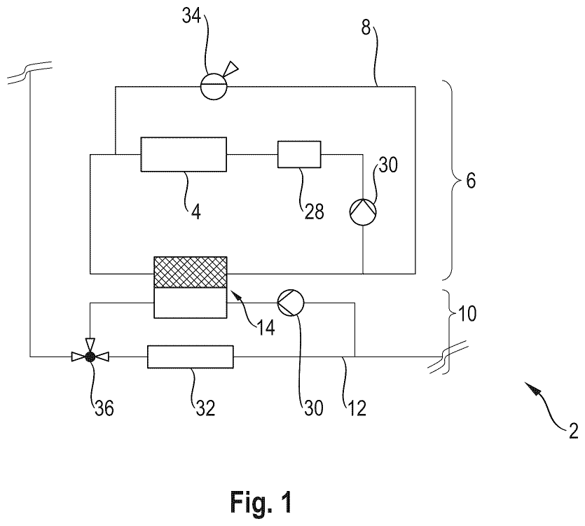

FIG. 1 shows the construction of a cooling system 2 according to an embodiment of the invention for a vehicle having a high-voltage battery 4.

As can be seen from FIG. 1, the cooling system 2 comprises an oil cooling circuit 6 for cooling the high-voltage battery 4 having a first line system 8 for distributing an oil as a coolant and a water-based cooling circuit 10 for cooling further components of the vehicle having a second line system 12 for distributing a water-based coolant, wherein a heat exchanger 14 is arranged between the oil cooling circuit 6 and the water-based cooling circuit 10 for dissipating heat from the oil cooling circuit 6 through the water-based cooling circuit 10. Furthermore, an oil insertion point 34 for introducing oil into the oil cooling circuit 6, an oil filter 28 for filtering contaminants, and a pump 30 arranged within the oil cooling circuit 6 and the water-based cooling circuit 10 can be seen. Furthermore, a chiller 32 for cooling the water-based coolant and a three-way valve 36 for regulating a cooling supply through the water-based cooling circuit 10 are also provided within the water-based cooling circuit 10.

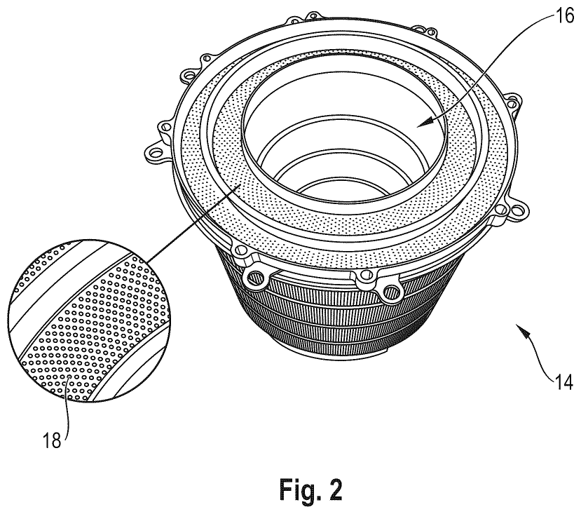

FIG. 2 shows a part of a heat exchanger 14 according to an embodiment of the invention in a spatial view.

As can be seen in FIG. 2, the heat exchanger 14 is configured in the form of a capillary heat exchanger and comprises a hollow cylinder 16 for passing the oil through and a plurality of microchannels 18 for the water-based coolant to pass through.

The microchannels 18 are arranged symmetrically directly around the hollow cylinder 16 and are connected to each other for example via warp wires.

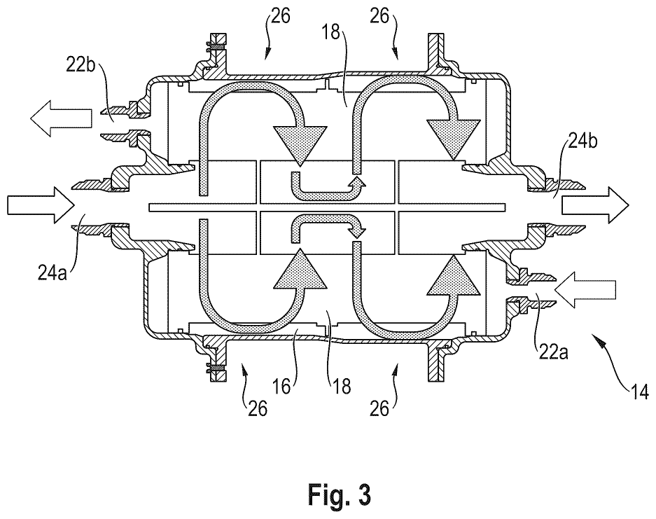

FIG. 3 shows a part of a heat exchanger 14 according to an embodiment of the invention in a sectional view.

As can be seen in FIG. 3, the hollow cylinder 16 for passing the oil through has a plurality of deflections 26 for changing a flow direction, which are arranged at least partially at an angle to the bundle of microchannels 18. The heat exchanger 14 also has inlet openings 22a for introducing a water-based coolant and outlet openings 22b for introducing a water-based coolant and inlet openings 24a for introducing an oil-based coolant, and outlet openings for executing an oil-based coolant.

Thus, the water-based coolant can be introduced into the hollow cylinder 16 through the front face of the microchannels 18, be conveyed axially through the microchannels 18 to the opposite side of the hollow cylinder 16, and then be removed out of the hollow cylinder 16. The oil-based coolant can also be introduced into the hollow cylinder 16, conveyed through the hollow cylinder 16 along the deflections 26 with increased contact to the microchannels 18 and then conveyed out of the hollow cylinder 16.

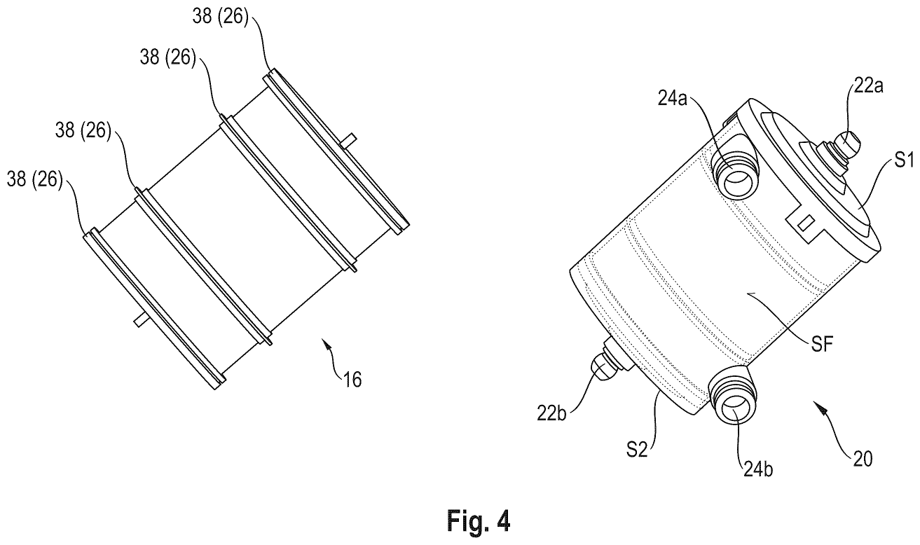

FIG. 4 shows a hollow cylinder 16 of a heat exchanger 14 according to an embodiment of the invention in a spatial view (left) and a housing 20 of a heat exchanger 14 according to an embodiment of the invention (right).

As can be seen in FIG. 4 (left), the hollow cylinder 16 has a plurality of sealing rings 38 for sealing and generating the deflections 26 (flow deflection of the oil).

As can be seen in FIG. 4 (right), the heat exchanger 14 comprises a housing 20 having an inlet connection 22a for introducing a water-based coolant and an outlet connection 22b for removing the water-based coolant, wherein the inlet connection 22a and the outlet connection 22b are arranged opposite front faces S1, S2 of the housing 20. In addition, the housing 20 comprises an inlet connection 24a for introducing an oil as a coolant and an outlet connection 24b for removing the oil arranged on the same side face SF of the housing 20.

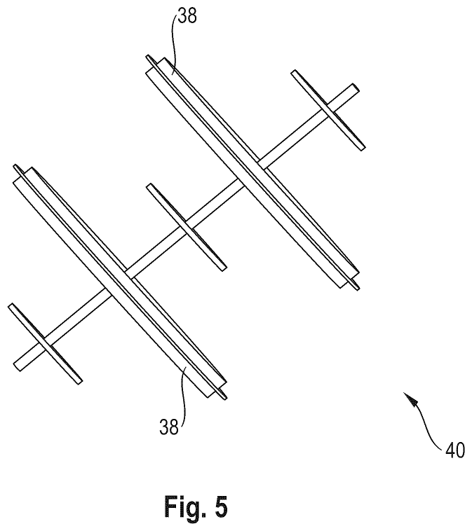

FIG. 5 finally shows a retaining structure 40 of a heat exchanger 14 according to an embodiment of the invention for fixing a plurality of microchannels 18 with sealing rings 38.

The above explanation of the embodiments describes the present invention solely in the context of examples. Of course, individual features of the embodiments can be freely combined with one another, if technically meaningful, without leaving the scope of the present invention.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

1. A cooling system for a vehicle having a high-voltage battery, comprising:
an oil cooling circuit for cooling the high-voltage battery with a first line system for distributing an oil as a coolant;
a water-based cooling circuit for cooling further components of the vehicle with a second line system for distributing a water-based coolant; and
a heat exchanger,
wherein the heat exchanger is arranged between the oil cooling circuit and the water-based cooling circuit for dissipating heat from the oil cooling circuit through the water-based cooling circuit.

2. The cooling system according to claim 1, wherein the heat exchanger is configured in the form of a capillary heat exchanger,
wherein the heat exchanger comprises a hollow cylinder for passing the oil through and a plurality of microchannels for passing the water-based coolant through, and
wherein the microchannels are woven.

3. The cooling system according to claim 2, wherein the microchannels are arranged directly around the hollow cylinder, and
wherein the microchannels are connected to each other via warp wires.

4. The cooling system according to claim 1, wherein the heat exchanger comprises a housing having an inlet connection for introducing a water-based coolant and an outlet connection for removing the water-based coolant.

5. The cooling system according to claim 1, wherein the heat exchanger comprises a housing having an inlet connection for introducing an oil as coolant and an outlet connection for removing the oil.

6. The cooling system according to claim 1, wherein the hollow cylinder for passing the oil through has a plurality of deflections for changing a flow direction.

7. The cooling system according to claim 1, wherein the plurality of deflections are arranged at an angle to the microchannels.

8. The cooling system according to claim 1, wherein the microchannels are made of a plastic or a metal material.

9. The cooling system according to claim 1, wherein the microchannels have an external diameter of between 0.2 mm and 4.0 mm.

10. A vehicle comprising:
a high-voltage battery; and
the cooling system according to claim 1.

11. The vehicle according to claim 10, wherein the high-voltage battery is arranged within the oil cooling circuit.

12. The cooling system according to claim 3, wherein the microchannels are arranged symmetrically around the hollow cylinder.

13. The cooling system according to claim 4, wherein the inlet connection and the outlet connection are arranged at opposite front faces of the housing.

14. The cooling system according to claim 5, wherein the inlet connection and the outlet connection are arranged on a same side face of the housing.

15. The cooling system according to claim 6, wherein the hollow cylinder has at least three deflections for changing the flow direction.

16. The cooling system according to claim 7, wherein the plurality of deflections are arranged substantially perpendicular to the microchannels.

17. The cooling system according to claim 9, wherein the microchannels have an external diameter of between 0.5 mm and 2.0 mm.

18. The vehicle according to claim 11, wherein the high-voltage battery is actively cooled exclusively via the oil cooling circuit.
